(19) United States
(12) Patent Application Publication
(10) Pub. No.: US 2024/0110641 A1
(43) Pub. Date: Apr. 4, 2024

(54) J-HOOK

(71) Applicant: Southwire Company, LLC, Carrollton, GA (US)

(72) Inventor: Steven M. Caramico, Patchogue, NY (US)

(73) Assignee: Southwire Company, LLC, Carrollton, GA (US)

(21) Appl. No.: 18/479,912

(22) Filed: Oct. 3, 2023

Related U.S. Application Data
(60) Provisional application No. 63/378,153, filed on Oct. 3, 2022.

(51) Int. Cl. F16L 3/06; H02G 3/30

(52) U.S. Cl. CPC F16L 3/06; H02G 3/30; G02B 6/4452

(57) ABSTRACT

A J-hook may be provided. The J-hook may comprise a main section and a latching pin. The main section may comprise a first portion comprising a latching pin hole, a second portion comprising a keyhole, and a saddle portion connecting the first portion to the second portion. The latching pin may be disposed in the latching pin hole. The latching pin may comprise a button disposed at a first end of the latching pin, a compression device disposed between the button and a first portion outside, and a latching stud disposed at a second end of the latching pin. The compression device may cause the latching stud to apply a pressure against a second portion outside when the latching pin is disposed in the keyhole.

### RELATED APPLICATION

Under provisions of 35 U.S.C. § 119(e), Applicant claims the benefit of U.S. Provisional Application No. 63/378,153, filed Oct. 3, 2022, which is incorporated herein by reference in its entirety.

### BACKGROUND

Cable management refers to management of electrical or optical cable in a cabinet or an installation. The term is used for products, workmanship, or planning. Cables may become tangled, making them difficult to work with, sometimes resulting in devices accidentally becoming unplugged as one attempts to move a cable. Cable management both supports and contains cables during installation and makes subsequent maintenance or changes to the cable system easier. Products such as cable trays, cable ladders, and cable baskets are used to support a cable through cabling route.

### BRIEF DESCRIPTION OF THE FIGURES

The accompanying drawings, which are incorporated in and constitute a part of this disclosure, illustrate various embodiments of the present disclosure. In the drawings:

FIG. 1 shows an isometric view of a J-hook;

FIG. 2 shows a front view of a J-hook;

FIG. 3 shows a back view of a J-hook; and

FIG. 4 shows a side view of a J-hook.

### DETAILED DESCRIPTION

### Overview

A J-hook may be provided. The J-hook may comprise a main section and a latching pin. The main section may comprise a first portion comprising a latching pin hole, a second portion comprising a keyhole, and a saddle portion connecting the first portion to the second portion. The latching pin may be disposed in the latching pin hole. The latching pin may comprise a button disposed at a first end of the latching pin, a compression device disposed between the button and a first portion outside, and a latching stud disposed at a second end of the latching pin. The compression device may cause the latching stud to apply a pressure against a second portion outside when the latching pin is disposed in the keyhole.

Both the foregoing overview and the following example embodiments are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Cable support systems including cable tray, raceway, and J-Hooks may support cables from a telecommunications room to a work area for example. Among them, J-Hooks may comprise a flexible, efficient, and economical solution for support when cables may be installed in confined areas that may not accommodate cable trays or raceways.

A J-Hook may resemble the letter “J” and may be made of galvanized steel or of plastic polymers, allowing for both indoor and outdoor installation. J-Hooks may be widely used for cable support because they may be easy to reconfigure, offering flexibility, speed, and economy in installation. J-Hooks may feature a wide base with smooth, rounded corners to eliminate the potential for snags during installation, while preventing the development of stress points where a cable bundle may be supported. In addition, J-Hooks may maintain a correct cable bend radius, which may make them less likely to pinch helping to ensure the integrity of a cabling system.

J-Hooks may offer an easy-to-install, non-continuous cable support for different types of telecommunication, data and power cabling, such as Category cables (e.g., cat3, cat5e, cat6, cat6a, etc.), optical fiber cables, and coax cables for example. In addition, there may be some J-Hook for low voltage and fire protection cabling, meeting the related standard requirement.

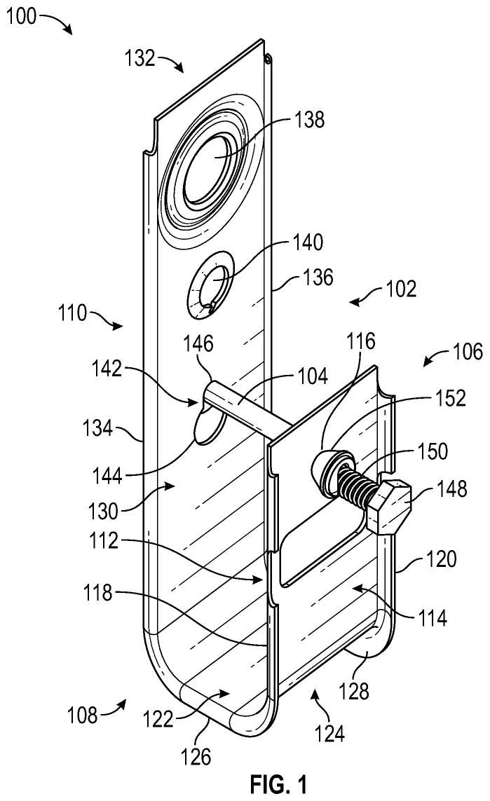

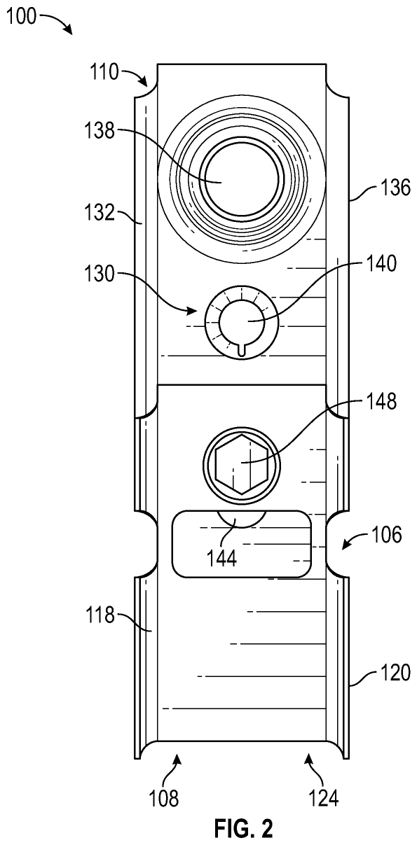

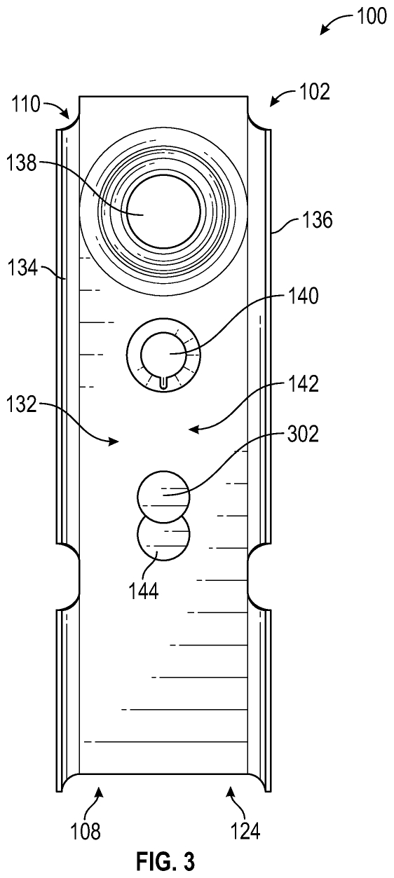

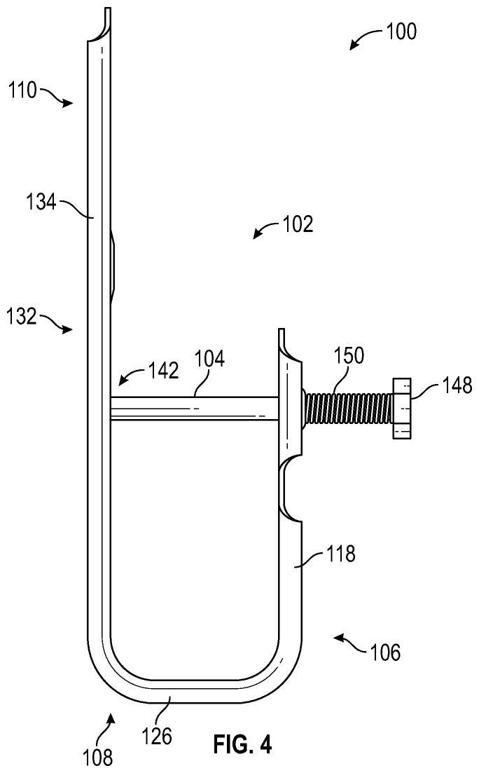

FIG. 1 shows an isometric view of a J-hook 100, FIG. 2 shows a front view of J-hook 100, FIG. 3 shows a back view of J-hook 100, and FIG. 4 shows a side view of J-hook 100. As shown in FIG. 1, FIG. 2, FIG. 3, and FIG. 4, J-hook 100 may comprise a main section 102 and a latching pin 104.

Main section 102 may comprise a first portion 106, a saddle portion 108, and a second portion 110. First portion 106 and second portion 110 may be parallel for example. Saddle portion 108 may connect first portion 106 to second portion 110. First portion 106 may comprise a first portion inside 112, a first portion outside 114, a latching pin hole 116, a first portion first curved edge 118, and a first portion second curved edge 120.

Saddle portion 108 may comprise a saddle portion inside 122, a saddle portion outside 124, a saddle portion first curved edge 126, and a saddle portion second curved edge 128. Second portion 110 may comprise a second portion inside 130, a second portion outside 132, a second portion first curved edge 134, a second portion second curved edge 136, a first mounting hole 138, a second mounting hole 140, and a keyhole 142.

Keyhole 142 may comprise a first keyhole section 144 and a second keyhole section 146. Latching pin 104 may comprise a button 148, a compression device 150, a compression device cup 152, and a latching stud 302. Compression device 150 may comprise, but is not limited to, a spring and may be disposed around latching pin 104.

As shown in FIG. 4, consistent with embodiments of the disclosure, compression device 150 may cause latching stud 302 to apply a pressure against second portion outside 132 when latching pin 104 is disposed in keyhole 142. First keyhole section 144 may be configured to allow latching stud 302 to pass through first keyhole section 144. Second keyhole section 146 may be configured to not allow latching stud 302 to pass through second keyhole section 146. Latching pin 104 may be configured to pass between first keyhole section 144 and second keyhole section 146 when latching pin 104 is in keyhole 142. Embodiments of the disclosure may further comprise an embossment in second portion outside 132 around second keyhole section 146 configured to allow latching stud 302 to seat in the embossment.

Consistent with embodiments of the disclosure, a user may initiate a latching pin 104 manipulation process. For example, the user may place a finger against button 148 and push button 148 further compressing compression device 150. This may cause latching stud 302 to move away from the seat in the embossment away from second portion outside 132. The user may then manipulate the finger to cause latching pin 104 to pass from second keyhole section 146 to first keyhole section 144. As stated above, first keyhole section 144 may allow latching stud 302 to pass through first keyhole section 144 and second keyhole section 146 may allow latching stud 302 to not pass through second keyhole section 146. Because the user manipulating the finger to cause latching pin 104 to pass from second keyhole section 146 to first keyhole section 144, the user may decompress compression device 150 with the finger that may allow latching stud 302 to pass back through first keyhole section 144. The user may further pull on button 148 causing latching pin 104 to no longer block saddle portion 108. A cable may be placed in saddle portion 108 and the aforementioned latching pin 104 manipulation process may be reversed causing latching pin 104 to block saddle portion 108 as shown in FIG. 4.

Compression device cup 152 may be disposed between an end of the compression device 150 and first portion outside 114. For example, compression device cup 152 may retain compression device 150 and allow latching pin 104 to be more easily manipulated by the user.

Consistent with embodiments of the disclosure, latching pin 104 may be retained by first portion 106. For example, this may allow the user to not lose latching pin 104 because it may be retained by first portion 106.

J-Hook 100 may be mounted to a structure (e.g., a wall). Retention devices (e.g., nails, screws, etc.) may be disposed in first mounting hole 138, second mounting hole 140, or both in order to mount J-Hook 100 to the structure. Consistent with embodiments of the disclosure, when J-Hook 100 is mounted to the structure, second portion first curved edge 134 and second portion second curved edge 136 may provide a space between second portion outside 132 and the structure. The space may allow latching stud 302 to enter first keyhole section 144 and to allow latching pin 104 to move between second keyhole section 146 and first keyhole section 144.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. An apparatus comprising:
a main section comprising;
a first portion comprising a latching pin hole,
a second portion comprising a keyhole, and
a saddle portion connecting the first portion to the second portion; and
a latching pin disposed in the latching pin hole, the latching pin comprising;
a button disposed at a first end of the latching pin,
a compression device disposed between the button and a first portion outside, and
a latching stud disposed at a second end of the latching pin wherein the compression device causes the latching stud to apply a pressure against a second portion outside when the latching pin is disposed in the keyhole.

2. The apparatus of claim 1, wherein the keyhole comprises:
a first keyhole section configured to allow the latching stud to pass through the first keyhole section; and
a second keyhole section adjacent to the first keyhole section, the second keyhole section configured to not allow the latching stud to pass through the second keyhole section wherein the latching pin is configured to pass between the first keyhole section and the second keyhole when the latching pin is in the keyhole.

3. The apparatus of claim 2, further comprising an embossment in a second portion outside around the second keyhole section configured to allow the latching stud to seat in the embossment.

4. The apparatus of claim 2:
wherein the second portion comprises a second portion first curved edge and a second portion second curved edge; and
wherein when the apparatus is mounted to a wall, the second portion first curved edge and the second portion second curved edge provide a space between a second portion outside and the wall wherein the space is configured to allow the latching stud to enter the first keyhole section and to allow the latching pin to move between the second keyhole section to the first keyhole section.

5. The apparatus of claim 1, wherein the latching pin is retained by the first portion.

6. The apparatus of claim 1, wherein the first portion and the second portion are parallel.

7. The apparatus of claim 1, wherein the compression device is disposed around the latching pin.

8. The apparatus of claim 1, wherein the compression device comprises a spring.

9. The apparatus of claim 1, wherein the latching pin further comprises a compression device cup disposed between an end of the compression device and a first portion outside.

10. The apparatus of claim 1, wherein the second portion comprises a first mounting hole.

11. The apparatus of claim 1, wherein the second portion comprises a second mounting hole.

12. An apparatus comprising:
a main section comprising;
a first portion comprising a latching pin hole, and
a second portion comprising a keyhole;
a latching pin disposed in the latching pin hole, the latching pin comprising;
a button disposed at a first end of the latching pin,
a compression device disposed between the button and a first portion outside, and
a latching stud disposed at a second end of the latching pin wherein the compression device causes the latching stud to apply a pressure against a second portion outside when the latching pin is disposed in the keyhole;
wherein the keyhole comprises:
a first keyhole section configured to allow the latching stud to pass through the first keyhole section, and
a second keyhole section adjacent to the first keyhole section, the second keyhole section configured to not allow the latching stud to pass through the second keyhole section wherein the latching pin is configured to pass between the first keyhole section and the second keyhole when the latching pin is in the keyhole; and
an embossment in a second portion outside around the second keyhole section configured to allow the latching stud to seat in the embossment.

13. The apparatus of claim 12:
wherein the second portion comprises a second portion first curved edge and a second portion second curved edge; and
wherein when the apparatus is mounted to a wall, the second portion first curved edge and the second portion second curved edge provide a space between a second portion outside and the wall wherein the space is configured to allow the latching stud to enter the second keyhole section and to allow the latching pin to move from the second keyhole section to the first keyhole section.

14. The apparatus of claim 12, wherein the latching pin is retained by the first portion.

15. The apparatus of claim 12, wherein the first portion and the second portion are parallel.

16. The apparatus of claim 12, wherein the compression device is disposed around the latching pin.

17. The apparatus of claim 12, wherein the compression device comprises a spring.

18. An apparatus comprising:
a main section comprising;
a first portion comprising a latching pin hole, and
a second portion comprising a keyhole;
a latching pin disposed in the latching pin hole, the latching pin comprising;
a button disposed at a first end of the latching pin,
a compression device disposed between the button and a first portion outside, and
a latching stud disposed at a second end of the latching pin wherein the compression device causes the latching stud to apply a pressure against a second portion outside when the latching pin is disposed in the keyhole;
wherein the keyhole comprises:
a first keyhole section configured to allow the latching stud to pass through the first keyhole section, and
a second keyhole section adjacent to the first keyhole section, the second keyhole section configured to not allow the latching stud to pass through the second keyhole section wherein the latching pin is configured to pass between the first keyhole section and the second keyhole when the latching pin is in the keyhole;
wherein the second portion comprises a second portion first curved edge and a second portion second curved edge; and
wherein when the apparatus is mounted to a wall, the second portion first curved edge and the second portion second curved edge provide a space between a second portion outside and the wall wherein the space is configured to allow the latching stud to enter the first keyhole section and to allow the latching pin to move between the second keyhole section to the first keyhole section.

19. The apparatus of claim 18, further comprising an embossment in a second portion outside around the second keyhole section configured to allow the latching stud to seat in the embossment.

20. The apparatus of claim 18, wherein the latching pin further comprises a compression device cup disposed between an end of the compression device and a first portion outside.
